(19) United States
(12) Patent Application Publication
(10) Pub. No.: US 2018/0313011 A1
(43) Pub. Date: Nov. 1, 2018

(54) FLUID PROCESSING SYSTEM FOR A FIBER TREATMENT SYSTEM

(71) Applicant: AUTEFA SOLUTIONS GERMANY GMBH, Friedberg (DE)

(72) Inventors: Joachim BINNIG, Jettingen-Scheppach (DE); Michael NIKLAUS, Seuzach (CH)

(21) Appl. No.: 15/769,911

(22) PCT Filed: Oct. 21, 2016
(86) PCT No.: PCT/EP2016/075340

§ 371 Date: Apr. 20, 2018

(30) Foreign Application Priority Data
Oct. 23, 2015 (DE) 20 2015 105 631.1

(51) Int. Cl. D04H 18/04; D04H 1/492; B01D 53/26

(52) U.S. Cl. CPC D04H 18/04; C02F 1/001; B01D 53/265; D04H 1/492

(57) ABSTRACT

A fluid processing system (2) for a fiber treatment system (1), which fluid processing system (2) has a moistening device (6), in particular a water-jet consolidating device, for a textile material web (3) and a preferably thermal drying device (7) for the moist material web (3). The moistening device (6) introduces process water (19) into the material web (3), which process water is removed from the material web (3) in the drying process. The fluid processing system (2) has fluid circuits (9, 10) and a regenerating device (16) for the process water (19) that is introduced into the material web (3) and thereafter removed and for the wastewater (32) arising in the process of moistening the material web (3).

### CROSS REFERENCE TO RELATED APPLICATIONS

This application is a United States National Phase Application of International Application PCT/EP2016/075340, filed Oct. 21, 2016, and claims the benefit of priority under 35 U.S.C. § 119 of German Application 20 2015 105 631.1, filed Oct. 23, 2015, the entire contents of which are incorporated herein by reference.

### FIELD OF THE INVENTION

The present invention pertains to fluid processing system for a treatment system, especially for a fiber treatment system, with a moistening device, especially a hydroentanglement device, for a textile material web and a preferably thermal drying device or the moist material web, wherein the moistening device introduces process water into the material web, which process water is again removed from the material web during the drying.

### BACKGROUND OF THE INVENTION

Fiber processing systems, in which a material web consisting of textile fibers is produced, possibly laid with a nonwoven-layering apparatus into a multilayer nonwoven and subsequently strengthened as well as possibly subjected to further processing, are known from practice. The strengthening may be carried out by means of a hydroentanglement device, wherein the material web is moistened. The strengthened material web is again dried in a downstream drying device, wherein the moisture contained is removed from the material web. The processing of the process water used during the moistening of the material web and during the removal of moisture from the material web is problematic.

### SUMMARY OF THE INVENTION

An object of the present invention is to provide an improved fluid processing technique.

The fluid processing technique according to the invention, the device technology of the fluid processing system and the processing method, as well as the fiber treatment system equipped therewith, have various advantages.

The process water used can be extensively regenerated and recycled. The feed of fresh water can be reduced. The evaporation heat used during the moisture removal by thermal effect, especially drying, can also extensively be recovered, and the energy consumption can be reduced. The moisture removal device, and possibly the moistening device as well as, if necessary, additional consumers in the fiber treatment system can be supplied the recovered thermal energy in a heat circuit. In addition, the process gas, especially drying air, which is used during the moisture removal, preferably thermal drying, can likewise be circulated. As a result, the consumption of resources can be reduced even further.

The fluid processing technique according to the present invention may be used for any desired material webs and for any desired methods and devices for moistening the material web and for removing moisture therefrom. There are special advantages in the case of the textile material web mentioned. This may consist, e.g., of a fibrous nonwoven. This is a fed material web. This material web may have been manufactured in any desired manner and then fed to the moistening device, especially a hydroentanglement device.

The total quantity of process water used is not introduced into the material web during the moistening, especially the hydroentanglement. The percentages of process water not introduced represent wastewater and may be collected and likewise fed to the regenerating device in a fluid circuit and reprocessed. The reprocessing of the process water can be increased even further hereby and the need for fresh water can be reduced.

The fluid circuits for the process water and for the wastewater are advantageously connected to one another. The wastewater collected separately may be fed into the fluid circuit of the process water and subjected to regeneration together with this. A common regenerating device is preferably provided for process water and wastewater. In particular, the process water and the wastewater may be purified and freed from residues from the material web or from other foreign substances together. The regenerated process water with the wastewater added may again be fed to the moistening device and introduced repeatedly into the material web.

The regenerating device has a recovery device for the process water removed from the material during the removal of moisture. The removal of moisture is preferably carried out by admitting a heated process gas, especially drying air, to the material web. The process gas absorbs the process water contained or the moisture from the material web and forms the waste air of the drying process. The recovery of the process water is preferably brought about by condensation of the waste air. This may be carried out especially with a spraying device, which is operated with regenerated process water. This leads to an especially high regeneration and recovery factor.

The present invention is schematically shown in the drawings as an example. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of a fiber treatment system with a moistening and moisture removal device for a material web and with additional system components;

FIG. 2 is a schematic view of a hydroentanglement device; and

FIG. 3 is a schematic view of a regenerating device.

### DESCRIPTION OF THE PREFERRED EMBODIMENTS

Referring to the drawings, the present invention pertains to a fluid processing system (2) and to a fluid processing method. The present invention further pertains to a treatment system equipped therewith, especially to a fiber treatment system (1).

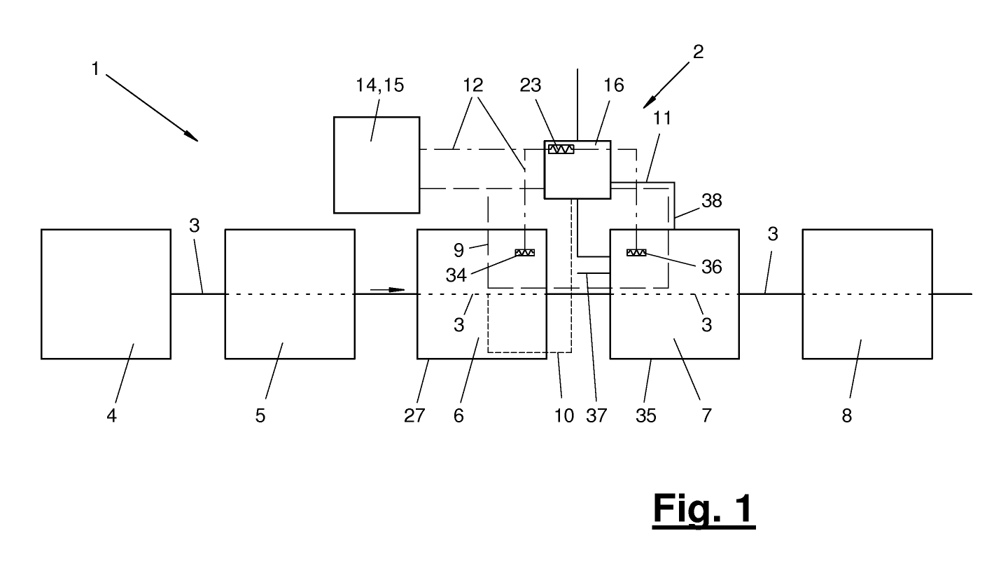

FIG. 1 shows such a fiber treatment system (1), which comprises a plurality of components, which are arranged one after another and through which a material web (3) passes in the direction of the arrow. The material web (3) may have any desired and suitable configuration. It preferably consists of textile fibers and is configured as a textile material web (3). It is preferably a fibrous nonwoven.

The fiber treatment system (1) has a web-forming device (4), which produces a single-web or multi-web fibrous nonwoven, which forms the material web (3) or at least a precursor for the material web (3). The web-forming device (4) may be configured in different ways, e.g., as a card or carder, as an airlay machine, a wet-laid nonwoven machine or the like. In addition, a fiber-processing unit is associated with the web-forming device (4). The web-forming device delivers the fibrous web or the material web (3) to a downstream laying device (5), which lays the fibrous web into a multilayer nonwoven and lays it at the same time. It is configured, e.g., as a nonwoven-layering apparatus, especially as a crosslapper.

The material web (3) formed by the multilayer nonwoven is then fed to a hydroentanglement device (6). The material web (3) is strengthened with water jets emitted under high pressure from a process water (19). The material web (3) is moistened in the process and it absorbs part of the process water (19).

The moist material web (3) is subsequently fed to a drying device (7), in which the material web (3) is dried and moisture is removed from it. This may be carried out in any desired manner, preferably with a heated process gas flow, especially air gas flow.

The dried material web (3), from which moisture has been removed, may subsequently be removed and possibly fed to another treatment device (8). Here, the material web (3) may, e.g., be wound up, trimmed and split or treated or processed further in another manner. The treatment device (8) may contain a plurality of components and stages.

In another embodiment of a fiber treatment system, not shown, the material web (3) may be produced in another manner, e.g., as a fabric. In addition, the moistening of the material web (3) may serve other purposes, in which case the moistening device (6) has a different configuration. The so-called process water (19) may also contain, in addition to water, other substances or it may, as an alternative, also consist of other substances instead of water. The moistening may be, e.g., dyeing or impregnating of the material web.

Further, the removal of moisture from the material web (3) and the removal of the process water (19) contained may be carried out in another manner. This may be carried out, e.g., by heat irradiation. The process of removing moisture may, in addition, be a secondary aspect of another treatment process for the material web (3).

The following explanations and features of the preferred fiber treatment system (1) with a hydroentanglement device (6) and with a drying device (7) correspondingly also apply to other above-mentioned configurations and intended uses of a moistening and moisture removal device (6, 7).

The total amount of fluid or the fluid balance may be divided into the so-called process water (19), the wastewater (32) and fresh water. The so-called water maybe defined here as H₂O as well as other fluids.

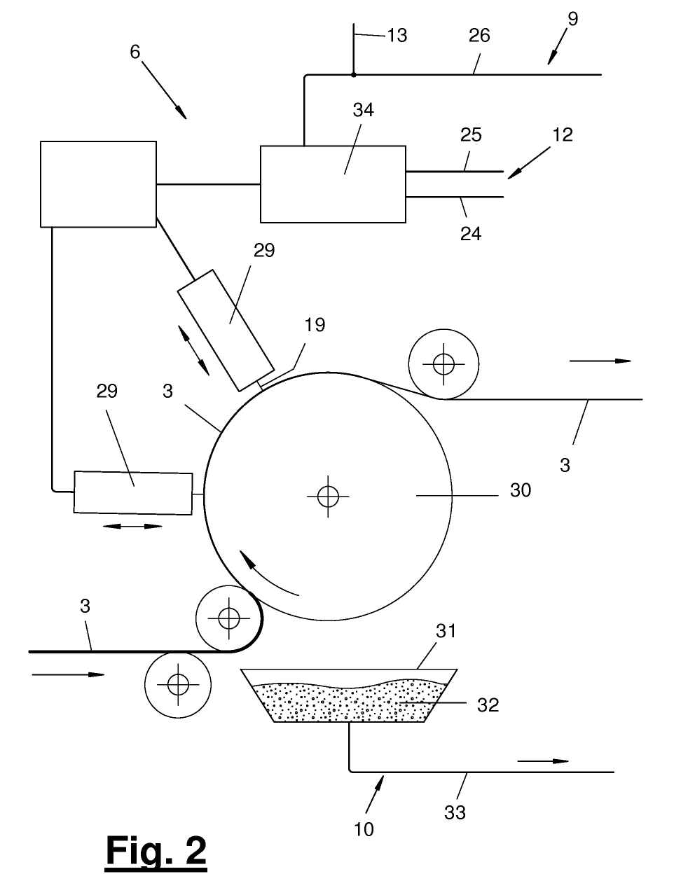

FIG. 2 schematically shows a hydroentanglement device (6), which may be accommodated, e.g., in a surrounding housing (27). The material web (3) is fed by a conveying device (28), transported through the hydroentanglement device (6) and is again removed at the outlet. The material web (3) is guided in the process over a preferably water-permeable, supporting web support (30), which is configured, e.g., as a perforated, rotating drum or as a perforated belt and may be present as a plurality of such web supports. The hydroentanglement of the material web (3) is brought about by a spraying device (29), which is equipped with one or more spray heads and which emit water jets of process water (19) with high pressure against the material web (3) being supported on the web support (30).

Only part of the emitted process water (19) is absorbed in and moistens the material web (3) during the hydroentanglement. Another part of the process water (19) passes through the material web (3) and enters or moves behind the web support (30) and is absorbed or drawn off there and is possibly separated from the transport air. Another part may occur in the form of splash water or as moisture mist. The parts of the emitted process water not introduced during the hydroentanglement are collected as so-called wastewater (32) in a collection device (31) shown schematically.

The wastewater (32) may contain foreign substances, e.g., sizing agent, fiber residues and the like, which are removed from the material web (3) during the hydroentanglement. Further, other foreign substances may also be contained in the wastewater (32). The wastewater (32) is removed via a line (33). The process water (19) used for the hydroentanglement may possibly be conditioned, e.g., decalcified, heated or treated in another manner prior to the emission of the water jets. A conditioning device may be present for this in the hydroentanglement device (6). This may possibly also contain a heat consumer (34), especially a heat exchanger. A heat consumer (34) may also be used, e.g., to preheat the material web (3) or for other purposes.

The drying device (7) is not shown specifically. It has a housing (35) and a heating device (36) as well as a processing device for the drying process. For example, drying air or another process gas or drying gas may be used here. The process gas heated with the heating device (36) may be blown, e.g., in a meandering gas flow towards and through the material web (3). The process gas, which is preferably moved in counterflow, now absorbs the process water (19) contained in the material web (3) and forms a humidified waste air (39). The waste air (39) may be discharged at an outlet (38), and incoming air or fresh air is fed in at an inlet (37).

The fiber treatment system (1) has a fluid processing system (2). This may be part of the original equipment of a fiber treatment system (1), or an existing fiber treatment system (1) may be retrofitted with it. The fluid processing system (2) may be an independent technical unit.

The fluid processing system (2) preferably connects the hydroentanglement device (6) and the downstream drying device (7). It may be used to process the process water (19) that is used there and is introduced into the material web (3) and also the wastewater (32). Further, it may ensure the recovery of the thermal energy used in the drying process. In addition, the process gas used in the drying process can be recycled.

The fluid processing system (2) has a regenerating device (16) and fluid circuits (9, 10) for the process water (19) introduced into the material web (3) and for the wastewater (32) generated during the hydroentanglement and moistening of the material web (3). The fluid circuit (9) for the process water (19) and the fluid circuit (10) for the wastewater (32) are shown schematically in FIG. 1.

The fluid circuits (9, 10) are connected to one another. If the circuits are connected, the wastewater (32) is fed into the fluid circuit (9) of the process water (19). The fluid circuits (9, 10) are preferably connected to a common regenerating device (16).

The fluid circuit (9) of the process water (19) extends over the moistening and moisture removal device (6, 7) and the hydroentanglement device and the drying device as well as the regenerating device (16) and includes the material web (3) as a moisture-transporting means or as a process water-transporting means. It may also reach other components of the fiber treatment system (1).

The fluid circuit (10) for the wastewater (32) extends over the moistening device (6) or the hydroentanglement device and the regenerating device (16). It is partially integrated, especially in the area of the return to the moistening device (6), into the fluid circuit (9) of the process water (19). The fluid circuit (10) may likewise have extensions.

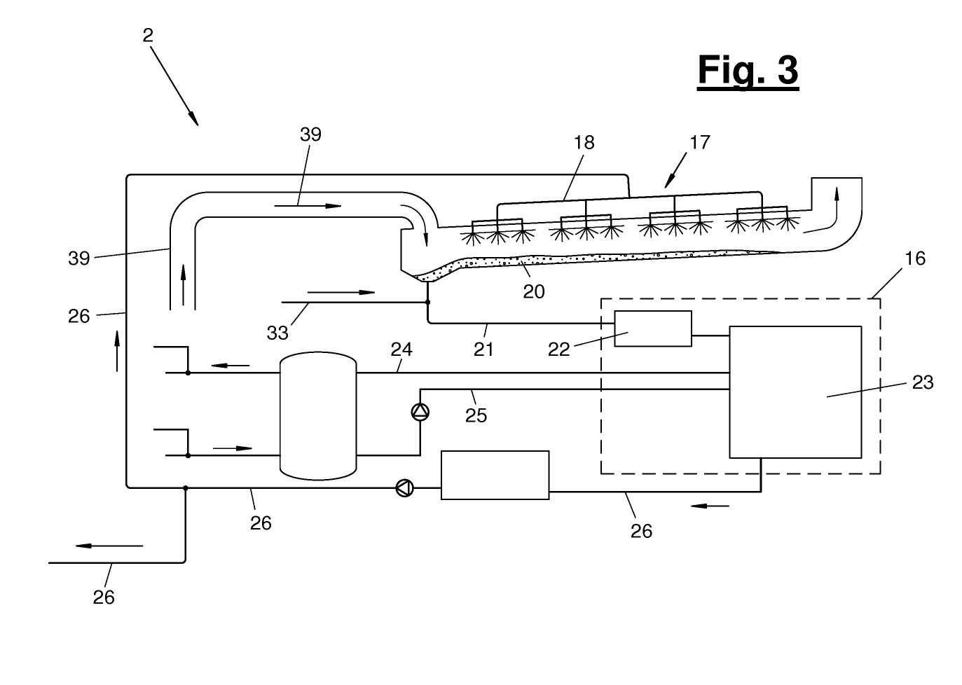

FIG. 3 shows the fluid processing system (2) and the regenerating device (16). The regenerating device (16) has a recovery device (17) for the process water (19) removed from the material web (3) during the drying or moisture removal. In the embodiment shown, which is preferred, the recovery device (17) is configured as a condensation device for the waste air (39) of the moisture removal device (7) or drying device. The process water (19) is obtained as a condensate (20) during the condensation.

The regenerating device (16) has a common purifying device (22) for the process water (19), especially the condensate (20), and for the wastewater (32). The fluid circuits (9, 10) are connected together to the purifying device (22). The condensate (20) is fed via a line (21) to the purifying device (22) on the inlet side. The wastewater (32) is fed via the line (33) to the purifying device (22). The line (33) may be connected to the condensate line (21) or directly to the purifying device (22).

The purifying device (22) may have any desired and suitable configuration in order to remove the residues and foreign substances from the process water (19) and from the wastewater (32). This may be effected, e.g., by filtration, by chemical binding and/or by other purification methods.

The regenerating device (16) may further have a heat exchanger (23). This heat exchanger may be associated with the purifying device (22) in any desired and suitable manner, preferably arranged downstream of it. The purified process water consisting of the returned process water (19) and the wastewater (32) is sent through the heat exchanger (23), and the heat contained in it, which originates especially from the condensate (20), is removed. The heat exchanger (23) is connected to a heat circuit (12), and the hot water is removed via a line (24) and the cold water is returned via a line (25).

The heat exchanger (23) is connected via the heat circuit (12) and the line (24, 25) to at least one heat consumer (14, 34, 36) in the fiber treatment system (1). Such a heat consumer (36) may be, e.g., the heating device or a part of the heating device in the moisture removal or drying device (7). Another heat consumer (34) may be a heat exchanger for the mentioned conditioning of the process water prior to the emission of the water jets. Another heat consumer (14) may be arranged in another location in the fiber treatment system (1) and may be configured, e.g., as a space heater or as a heat exchanger for an air conditioner. Conditioning of the ambient air with setting or regulation of the respective temperature needed or of the humidity of the air is often necessary in the area surrounding the system and in the shop for the workers.

After passing through the heat exchanger (23), the cooled and regenerated process water (19) is again returned via a line (26) to the moistening device (6) or hydroentanglement device in said fluid circuit (9). Part of this regenerated process water (19) may also be used for the recovery of heat and condensation. Another part of the regenerated process water (19) may be fed, as needed, to other consumers (15) in the fiber treatment system (1), possibly with integration into the fluid circuit (9).

As is shown in FIG. 3, the condensation device (17) may have a spraying device (18), which sprays a cold fluid into the hot waste air (39) in a flow duct, as a result of which the temperature of the waste air is decreased and the portion of process water contained in the waste air (39) is condensed. The condensate (20) may be captured and collected on the bottom of the duct and fed to the regenerating device (16), especially to the purifying device (22), via said line (21). The regenerated cold process water (19) arriving from the regenerating device (16) may be used in the spraying device (18). The spraying device (18) is connected for this to the line (26) via a branch line.

Losses of water occur despite the fact that the fluid circuits (9, 10) for the process water (19) and the wastewater (32) are more or less closed. These losses are compensated by fresh water from a supply source (13). The fresh water supply source (13) may be located in any desired and suitable location in one of the fluid circuits (9, 10). For example, it is arranged in the moistening device or hydroentanglement device (6) according to FIG. 2.

The fluid circuit (9) for the process water (19) extends over said lines and encloses the material webs (3) as moisture-transporting means. The lines may be arranged in a network of lines, which also contains collection and buffer tanks as well as pumps and other hydraulic components, in addition to the pipelines.

The fluid circuit (11) for the process gas, especially for the drying air, which circuit was mentioned at the beginning, may comprise a partial or full return of the waste air (39) after it had been dried in the recovery or condensation device (17) and the direct feed thereof into the moisture removal or drying device (7). As a result, the residual heat still contained in the dried waste air (39) can be utilized. Losses of gas can also be avoided or reduced in the process, especially if the gas is a special process gas rather than simple ambient air. The residual heat in the waste air (39) may also be removed by a heat exchanger, which may possibly be integrated in the heat circuit (12).

Various modifications of the embodiments shown and described are possible. In particular, the features of the exemplary embodiments described and of the variants mentioned may be combined, especially transposed, with one another as desired.

The material web (3) may consist of any other desired, preferably flexurally elastic material, in which case the treatment system (1) has a correspondingly different configuration. The configuration of the system may be modified. The laying device (5) may, for example, be omitted, in which case the web-forming device (4) releases the material web (3) directly to the hydroentanglement device (6) or to the drying device.

While specific embodiments of the invention have been shown and described in detail to illustrate the application of the principles of the invention, it will be understood that the invention may be embodied otherwise without departing from such principles.

In the claims:

1. A fluid processing system for a fiber treatment system comprising a hydroentanglement device, for a textile material web and a thermal drying device for drying the moist material web, wherein the hydroentanglement device introduces process water into the material web, which process water is again removed from the material web during the drying, the fluid processing system comprising:
fluid circuits, and
a regenerating device for the process water, which was introduced into the material web and then removed again, and for wastewater generated during the hydroentanglement of the material web.

2-3. (canceled)

4. A fluid processing system in accordance with claim 1, wherein the regenerating device comprises a common regenerating device and the fluid circuits are connected to the common regenerating device.

5. A fluid processing system in accordance with claim 4, wherein:
the regenerating device has comprises a recovery device for recovery of the process water removed from the material web during the drying; and
the regenerating device comprises a common purifying device for purifying the process water condensate recovered from the drying and for purifying the wastewater.

6. A fluid processing system in accordance with claim 5, wherein the recovery device is configured as a condensation device for recovery of the process water condensate from a waste air of the drying device.

7-8. (canceled)

9. A fluid processing system in accordance with claim 6, wherein:
the condensation device comprises a spraying device for condensing the waste air;
the fluid circuits comprise a process water fluid circuit; and
the spraying device is connected to the process water fluid circuit and is operated with regenerated process water.

10-11. (canceled)

12. A fluid processing system in accordance with claim 4, wherein the regenerating device comprises a heat exchanger.

13. (canceled)

14. A fluid processing system in accordance with claim 1, further comprising:
a heat circuit; and
a fluid circuit for process gas comprising drying air used to dry the material web.

15. A fluid processing system in accordance with claim 12, wherein:
the heat exchanger is connected to a heat consumer of the hydroentanglement device or of the drying device or of both the hydroentanglement device and the drying device; and
the heat exchanger is connected to another heat consumer in the fiber treatment system.

16-17. (canceled)

18. A fiber treatment system comprising:
a hydroentanglement device for a textile material web;
a thermal drying device for drying the moist material web;
a fluid processing system comprising fluid circuits and a regenerating device for process water, which was introduced into the material web during the hydroentanglement and was removed from the material web during the thermal drying, and for wastewater generated during the hydroentanglement of the material web.

19. (canceled)

20. A fiber treatment system in accordance with claim 18, wherein the thermal drying device is configured with a heated process gas flow.

21. (canceled)

22. A fiber treatment system in accordance with claim 18, wherein
the fluid circuits comprise a process water fluid circuit; and
the process water fluid circuit extends over the hydroentanglement device, the drying device and the regenerating device.

23. A fiber treatment system in accordance with claim 20, further comprising an additional consumer; a heat circuit; and a process gas fluid circuit for process gas to dry the material web, wherein
the fluid circuits comprise a process water fluid circuit; and
the additional consumer is connected to the process water fluid circuit; for the process water; and
the additional consumer is connected to the heat circuit or to the process gas fluid circuit or to both the heat circuit and the process gas fluid circuit.

24. (canceled)

25. A fiber treatment system in accordance with claim 18, wherein the hydroentanglement device has a collection device for the wastewater generated during the hydroentanglement of the material web.

26. A fiber treatment system in accordance with claim 18, further comprising:
a web-forming device comprising a card or carder, an airlay machine or a wet-laid nonwoven machine, which is arranged upstream of the hydroentanglement device in the direction in which the material web runs; and
a treatment device for treating the material web, the treatment device being arranged downstream of the drying device in the direction in which the material web runs.

27. (canceled)

28. A method for processing fluids, the method comprising the steps of:
providing a fluid processing system in a fiber treatment system, which fiber treatment system comprises a hydroentanglement device, for a fed textile material web and a thermal drying device for thermally drying the material web:
hydroentangling the fed textile material web with the hydroentanglement device;
thermally drying the material web, with the thermal drying device, after the step of hydroentangling the fed textile material web;
introducing process water into the material web during the hydroentanglement;
removing process water from the material web during the thermal drying;
generating wastewater during the hydroentanglement of the material web
regenerating the process water removed and the wastewater generated together by means of fluid circuits and of a regenerating device.

29. A method in accordance with claim 28, wherein:
evaporation heat used during the thermal drying of the material web is recovered; and
regenerated process water and the recovered thermal energy are recycled.

30. (canceled)

31. A method in accordance with claim 28, wherein:
the regenerated process water with the wastewater added, is fed again to the hydroentanglement device and is reintroduced into the material web; or
the regenerated process water with the wastewater added is fed to another consumer; or
the regenerated process water with the wastewater added, is fed again to the hydroentanglement device and is reintroduced into the material web and the regenerated process water with the wastewater added is fed to another consumer.

32-33. (canceled)

34. A method in accordance with claim 29, wherein the drying device and the hydroentanglement device are supplied with recovered thermal energy in a heat circuit.

35. A method in accordance with claim 28, wherein:
the process water, which was removed from the material web during the drying, is recovered from waste air of the drying device by condensation as a condensate; and
the condensate and the wastewater are combined and are regenerated together.

36-37. (canceled)
